(19) United States
(12) Patent Application Publication
(10) Pub. No.: US 2023/0398710 A1
(43) Pub. Date: Dec. 14, 2023

(54) VEGETABLE CUTTING AND WASHING DEVICE

(71) Applicant: GENICOOK PRODUCT, LLC, GARLAND, TX (US)

(72) Inventors: Jianzhong Zhang, Handan (CN); Qingchuan Xie, Handan (CN)

(21) Appl. No.: 18/455,635

(22) Filed: Aug. 25, 2023

(51) Int. Cl. B26D 7/26; A47J 43/24

(52) U.S. Cl. CPC B26D 7/2614; A47J 43/24; B26D 2210/02; B26D 2007/0018

(57) ABSTRACT

A vegetable cutting and washing device provided by the utility model comprises a collection basin, a basin cover, a cover plate and a cutting blade for cutting vegetables. The basin cover is provided with a vegetable pouring port and a plurality of draining holes; the cover plate is detachably installed in the vegetable pouring port; the cover plate is provided with an installing hole; the cutting blade is detachably installed on the installing hole; and the basin cover is clamped with the collection basin through a clamping piece. The utility model relates to a vegetable cutting and washing device, and belongs to the technical field of food processing machinery. The utility model can directly collect vegetables after shredding or slicing for washing, so that the use is convenient and the preparation time of side dishes is shortened.

### TECHNICAL FIELD

The utility model relates to a vegetable cutting and washing device, and belongs to the technical field of food processing machinery.

### BACKGROUND

Whether in a family or in a canteen and a restaurant, vegetables need to be cut. At present, a sink is conventionally used for washing and manual cutting, but this practice is inefficient in the canteen and the restaurant, and easy to consume manpower in the family.

CN112401698A, which discloses a vegetable grater, is composed of a grater plate and a handle. The surface of the grater plate has a grating part. When use, vegetables are grated through the grating part, but the grated vegetables need to be washed in a washing basin, which is very tedious.

### SUMMARY

The technical problem to be solved by the utility model is to provide a vegetable cutting and washing device, which can directly collect vegetables after shredding or slicing for washing, so that the use is convenient and the preparation time of side dishes is shortened.

The technical solution of the utility model to solve the above technical problems is as follows: a vegetable cutting and washing device comprises a collection basin, a basin cover, a cover plate and a cutting blade for cutting vegetables; the basin cover is provided with a vegetable pouring port and a plurality of draining holes; the cover plate is detachably installed in the vegetable pouring port; the cover plate is provided with an installing hole; the cutting blade is detachably installed on the installing hole; and the basin cover is clamped with the collection basin through a clamping piece.

The utility model has the beneficial effects that: the vegetables are movably cut forward and backward on the cutting blade; the cut vegetables fall into the collection basin; the cover plate is taken down; the water is injected into the collection basin for washing; and the water is drained from the plurality of draining holes after washing, which is very convenient.

On the basis of the above technical solution, the utility model can also be improved as follows.

Further, a side wall of the installing hole is provided with a plurality of clamping slots; a plurality of clamping bulges are fixed on the cutting blade; and the plurality of clamping bulges can be correspondingly inserted into the plurality of clamping slots so that the cutting blade is installed on the cover plate.

The above further solution has the beneficial effects that: the plurality of clamping bulges on the cutting blade are inserted into the plurality of clamping slots, which is convenient for installation, and different cutting blades can be changed according to required cutting styles.

Further, an inner wall of the vegetable pouring port is inclined and protruded inwards to form a limiting bevel, and an edge of the cover plate is abutted against the limiting bevel.

The above further solution has the beneficial effects that: the cover plate for receiving is convenient to be opened to take the cut vegetables.

Further, a handle is fixed on the basin cover.

Further, the clamping piece comprises a plurality of clamping hooks; an opening edge of the collection basin extends outwards to form an annular bulge; one end of the plurality of clamping hooks is rotatably connected to the basin cover; and the other ends can be hooked on the annular bulge.

The above further solution has the beneficial effects that: the connection of the basin cover and the collection basin is facilitated through the hook connection.

Further, the vegetable cutting and washing device further comprises a sealing ring; the bottom of the basin cover is provided with an annular groove corresponding to a top edge of the collection basin; the top of the sealing ring is clamped on the annular groove; and the bottom is abutted against the top edge of the collection basin.

The above further solution has the beneficial effects that: the sealing effect is improved, and the water is prevented from spilling between the basin cover and the collection basin when the vegetables are washed.

Further, the edge of the cover plate is provided with a notch.

The above further solution has the beneficial effects that: the cover plate can be easily opened by inserting a finger into the notch.

Further, the vegetable cutting and washing device further comprises a non-slip pad, and the non-slip pad is bonded to the bottom of the collection basin.

### DESCRIPTION OF DRAWINGS

FIG. 1 is a structural schematic diagram of a vegetable cutting and washing device provided by the utility model;

FIG. 2 is an exploded diagram of FIG. 1;

FIG. 3 is an enlarged diagram of Part Ain FIG. 2;

FIG. 4 is a structural schematic diagram of a basin cover in a vegetable cutting and washing device provided by the utility model;

FIG. 5 is a structural schematic diagram of a basin cover in a vegetable cutting and washing device provided by the utility model from another angle.

In the figures, the list of components represented by each label is as follows:

1—collection basin, 2—basin cover, 21—vegetable pouring port, 22—draining hole, 23—annular groove, 3—cover plate, 31—installing hole, 32—clamping bulge, 33—notch, 4—cutting blade, 41—clamping slot, 5—clamping piece, 6—limiting bevel, 7—handle, 8—annular bulge, 9—sealing ring, 10—non-slip pad.

### DETAILED DESCRIPTION

The principles and features of the utility model will be described below in combination with drawings. Described examples are only used for explaining the utility model, but are not intended to limit the scope of the utility model.

The purpose of the utility model is to provide a vegetable cutting and washing device to solve the problem in the prior art, which can directly collect vegetables after shredding or slicing for washing, so that the use is convenient and the preparation time of side dishes is shortened.

To make the above purpose, features and advantages of the utility model more clear and understandable, the utility model will be further described below in detail in combination with the drawings and specific embodiments.

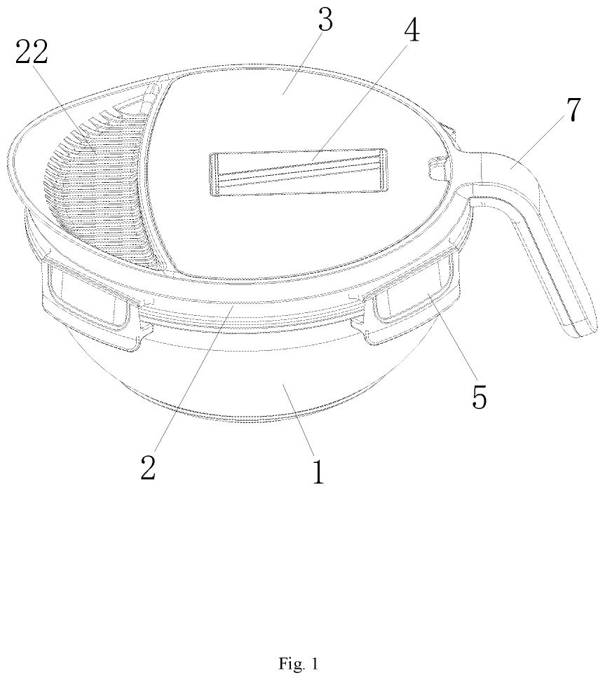

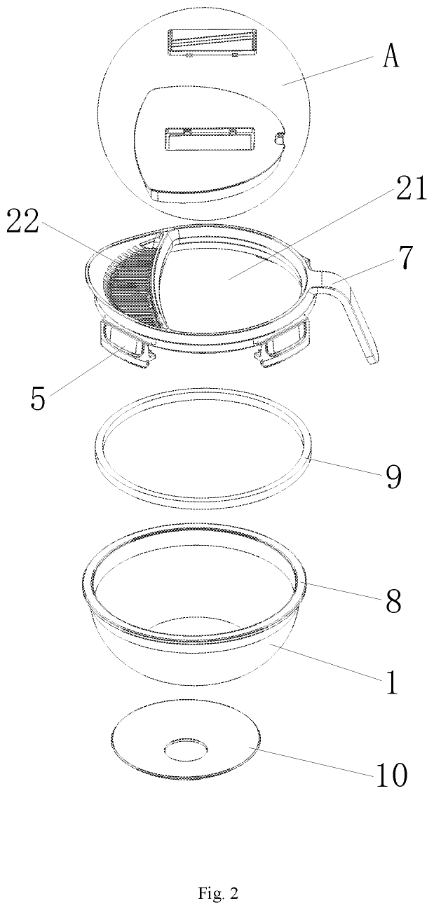

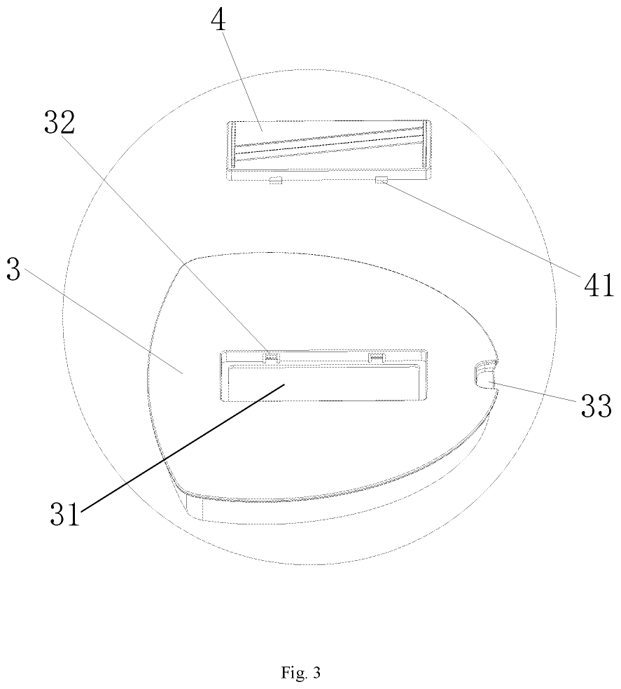

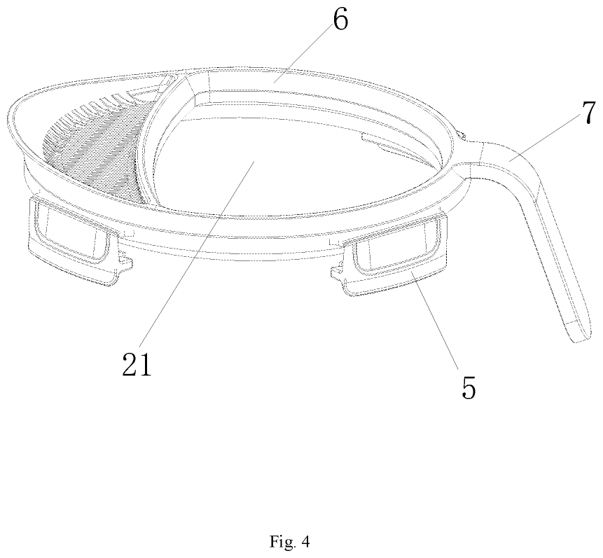

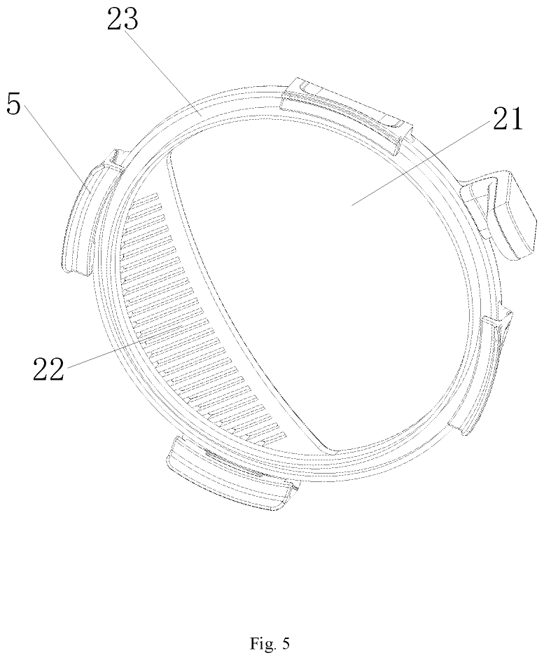

The utility model provides a vegetable cutting and washing device, as shown in FIGS. 1-5, comprising a collection basin 1, a basin cover 2, a cover plate 3 and a cutting blade 4 for cutting vegetables; the basin cover 2 is provided with a vegetable pouring port 21 and a plurality of draining holes 22; the cover plate 3 is detachably installed in the vegetable pouring port 21; the cover plate 3 is provided with an installing hole 31; the cutting blade 4 is detachably installed on the installing hole 31; and the basin cover 2 is clamped with the collection basin 1 through a clamping piece 5.

The utility model provides the vegetable cutting and washing device. The vegetables are movably cut forward and backward on the cutting blade 4; the cut vegetables fall into the collection basin 1; the cover plate 3 is taken down; the water is injected into the collection basin 1 for washing; and the water is drained from the plurality of draining holes 22 after washing, which is very convenient.

In a specific embodiment of the utility model, a side wall of the installing hole 31 is provided with a plurality of clamping slots 41; a plurality of clamping bulges 32 are fixed on the cutting blade 4; and the plurality of clamping bulges 32 can be correspondingly inserted into the plurality of clamping slots 41 so that the cutting blade 4 is installed on the cover plate 3.

The plurality of clamping bulges 32 on the cutting blade 4 are inserted into the plurality of clamping slots 41, which is convenient for installation, and different cutting blades 4 can be changed according to required cutting styles.

In a specific embodiment of the utility model, an inner wall of the vegetable pouring port 21 is inclined and protruded inwards to form a limiting bevel 6, and an edge of the cover plate 3 is abutted against the limiting bevel 6.

The cover plate 3 for receiving is convenient to be opened to take the cut vegetables.

In a specific embodiment of the utility model, a handle 7 is fixed on the basin cover 2.

In a specific embodiment of the utility model, the clamping piece 5 comprises a plurality of clamping hooks; an opening edge of the collection basin 1 extends outwards to form an annular bulge 8; one end of the plurality of clamping hooks is rotatably connected to the basin cover 2; and the other ends can be hooked on the annular bulge 8.

The connection of the basin cover 2 and the collection basin 1 is facilitated through the hook connection.

In a specific embodiment of the utility model, the vegetable cutting and washing device further comprises a sealing ring 9; the bottom of the basin cover 2 is provided with an annular groove 23 corresponding to a top edge of the collection basin 1; the top of the sealing ring 9 is clamped on the annular groove 23; and the bottom is abutted against the top edge of the collection basin 1.

When the plurality of clamping hooks are hooked on the annular bulge 8, the sealing ring 9 is pressed on the top edge of the collection basin 1 to improve the sealing effect and prevent the water from spilling between the basin cover 2 and the collection basin 1 when the vegetables are washed.

In a specific embodiment of the utility model, the edge of the cover plate 3 is provided with a notch 33.

The cover plate 3 can be easily opened by inserting a finger into the notch 33.

In a specific embodiment of the utility model, the vegetable cutting and washing device further comprises a non-slip pad 10, and the non-slip pad 10 is bonded to the bottom of the collection basin 1.

The above only describes preferred embodiments of the utility model and is not intended to limit the utility model. Any modification, equivalent replacement, improvement, etc. made within the spirit and the principle of the utility model shall be contained within the protection scope of the utility model.

1. A vegetable cutting and washing device, comprising a collection basin (1), a basin cover (2), a cover plate (3) and a cutting blade (4) for cutting vegetables, wherein the basin cover (2) is provided with a vegetable pouring port (21 and a plurality of draining holes (22); the cover plate (3) is detachably installed in the vegetable pouring port (21); the cover plate (3) is provided with an installing hole (31); the cutting blade (4) is detachably installed on the installing hole (31); and the basin cover (2) is clamped with the collection basin (1) through a clamping piece (5).

2. The vegetable cutting and washing device according to claim 1, wherein a side wall of the installing hole (31) is provided with a plurality of clamping slots (41); a plurality of clamping bulges (32) are fixed on the cutting blade (4); and the plurality of clamping bulges (32) can be correspondingly inserted into the plurality of clamping slots (41) so that the cutting blade (4) is installed on the cover plate (3).

3. The vegetable cutting and washing device according to claim 1, wherein an inner wall of the vegetable pouring port (21) is inclined and protruded inwards to form a limiting bevel (6), and an edge of the cover plate (3) is abutted against the limiting bevel (6).

4. The vegetable cutting and washing device according to claim 1, wherein a handle (7) is fixed on the basin cover (2).

5. The vegetable cutting and washing device according to claim 1, wherein the clamping piece (5) comprises a plurality of clamping hooks; an opening edge of the collection basin (1) extends outwards to form an annular bulge (8); one end of the plurality of clamping hooks is rotatably connected to the basin cover (2); and the other ends can be hooked on the annular bulge (8).

6. The vegetable cutting and washing device according to claim 5, further comprising a sealing ring (9), wherein the bottom of the basin cover (2) is provided with an annular groove (23) corresponding to a top edge of the collection basin (1); the top of the sealing ring (9) is clamped on the annular groove (23); and the bottom is abutted against the top edge of the collection basin (1).

7. The vegetable cutting and washing device according to claim 1, wherein the edge of the cover plate (3) is provided with a notch (33).

8. The vegetable cutting and washing device according to claim 1, further comprising a non-slip pad (10), wherein the non-slip pad (10) is bonded to the bottom of the collection basin (1).
